(19) United States
(12) Patent Application Publication
(10) Pub. No.: US 2010/0079906 A1
(43) Pub. Date: Apr. 1, 2010

(54) Adaptive Feed Forward Rotational Vibration Compensation During a SEEK Operation

(76) Inventors: Donald T. Wile, San Jose, CA (US); Stephen B. Cradock, San Francisco, CA (US); Ian Chen, Campbell, CA (US)

Correspondence Address: MORGAN, LEWIS & BOCKIUS, LLP. (PA), 2 PALO ALTO SQUARE, 3000 EL CAMINO REAL, SUITE 700, PALO ALTO, CA, 94306, US

(21) Appl. No.: 12/240,950

(22) Filed: Sep. 29, 2008

(51) Int. Cl. G11B 5/596

(52) U.S. Cl. 360/78.09

(57) ABSTRACT

A disk drive assembly includes a disk drive, one or more accelerometers, a control circuit, and an adaptive feed forward circuit. The one or more accelerometers generate acceleration signals that are used to detect rotational vibration (RV) events on the disk drive. The control circuit is configured to: generate one or more control signals, which are based on a control signal from a host system and a compensation signal from the adaptive feed forward circuit, and generate a position error signal (PES) that indicates an error in a position of a disk drive head relative to a center of a track. The adaptive feed forward circuit generates the compensation signal, which compensates for the detected RV events based on the acceleration signals and the PES. The compensation signal accounts for self-induced RV events generated by a SEEK operation that repositions the head to a new track, wherein feed forward adaption is not disturbed by the SEEK operation.

### TECHNICAL FIELD

The disclosed embodiments relate generally to compensating for self-induced rotational vibrations (RV) on a disk drive generated by SEEK operations.

### BACKGROUND

During operation, a disk drive can be subjected to rotational vibrations that can cause the heads of the disk drive to become off-track. These rotational vibrations can be induced from external sources and/or can be self-inducted from operations being performed by the heads (e.g., READ, WRITE, SEEK, etc.). Typically, a disk drive's control module (or circuit) reports a position error signal (PES). The PES is zero when the head is positioned on-track and goes either positive or negative if the head moves off-track. For example, if the head is on-track and the disk drive is subjected to RV, in the absence of RV compensation, the head moves off-track center and generates a disturbance in the PES.

In order to compensate for these rotational vibrations, an adaptive feed forward module (or circuit), which combines an adaptive gain technique and rotational vibration (RV) compensation, can be used in hard disk drives. The adaptive feed forward loop requires that the disk drive's PES accurately reflect the position error of the head relative to the track center. The PES can be used in conjunction with on board accelerometer signals to sense RV and to adapt a feed forward gain used to scale the RV signal. Once properly scaled, the RV signal can be fed into the disk drive's control module (e.g., a servo loop) to compensate for the effect of the RV on the head, thereby holding the head on-track.

Unfortunately, during a SEEK operation, the PES can saturate as the head is forced off-track by the drive's control module. This large PES can cause mis-adaptation of the feed forward gain, which in turn increases the amount of time it takes for the disk drive head to settle on-track at the target track specified by the SEEK operation. Prolonging the amount of time it takes to complete a SEEK operation is highly undesirable.

Thus, what is needed is a system and method for disabling feed-forward adaptation during a SEEK operation.

### SUMMARY OF EMBODIMENTS

Some embodiments provide a disk drive assembly including a disk drive, one or more accelerometers, a control circuit, and an adaptive feed forward circuit. The disk drive includes one or more heads and one or more tracks. The one or more accelerometers are configured to generate acceleration signals that are used to detect rotational vibration (RV) events on the disk drive. The control circuit is configured to: generate one or more control signals and generate a position error signal (PES) that indicates an error in a position of the respective head relative to a center of the respective track. A respective control signal, which is based at least in part on a control signal from a host system and a compensation signal from the adaptive feed forward circuit, positions a respective head on a respective track for the disk drive. The adaptive feed forward circuit is configured to generate the compensation signal, which compensates for the detected RV events based at least in part on the acceleration signals and the PES. The compensation signal accounts for self-induced RV events generated by a SEEK operation that repositions the respective head to a new track. Operation of at least a portion of the adaptive feed forward circuit is suppressed during the SEEK operation. In some embodiments, the at least the portion of the adaptive feed forward circuit is suppressed during the SEEK operation and for a specified time period after the SEEK operation has completed.

In some embodiments of a disk drive assembly, instead of suppressing at least a portion of the adaptive feed forward circuit during a SEEK operation, the control circuit generates a zero error signal for the PES that is received by the adaptive feed forward circuit from the control circuit when the disk drive is performing a SEEK operation.

Some embodiments provide a system including: one or more processors, memory, and one or more programs stored in the memory. The one or more programs include instructions to: receive from one or more accelerometers acceleration signals that are used to detect rotational vibration (RV) events on a disk drive, receive from a control circuit a position error signal (PES) that indicates an error in a position of a respective head relative to a center of a respective track, and generate a compensation signal based on the acceleration signals and the PES, wherein the compensation signal is used by the control circuit to compensate for the detected RV events. The compensation signal accounts for self-induced RV events generated by a SEEK operation that repositions the respective head to a new track. Operation of at least a portion of an adaptive feed forward circuit is suppressed during the SEEK operation. In some embodiments, the at least the portion of the adaptive feed forward circuit is suppressed during the SEEK operation and for a specified time period after the SEEK operation has completed.

In some embodiments of a system having one or more processors, memory, one or more programs stored in the memory and a disk drive, the one or more programs include instructions for generating a zero error signal for the PES that is received by the adaptive feed forward circuit from the control circuit when the disk drive is performing a SEEK operation, instead of having instructions for suppressing at least a portion of an adaptive feed forward circuit during a SEEK operation, the control circuit generates a zero error signal for the PES when the disk drive is performing a SEEK operation.

Some embodiments provide a computer readable storage medium storing one or more programs configured for execution by a computer. The one or more programs include instructions for receiving from one or more accelerometers acceleration signals that are used to detect rotational vibration (RV) events on a disk drive, receiving from a control circuit a position error signal (PES) that indicates an error in a position of a respective head relative to a center of a respective track, and generating a compensation signal based on the acceleration signals and the PES, wherein the compensation signal is used by the control circuit to compensate for the detected RV events. The compensation signal accounts for self-induced RV events generated by a SEEK operation that repositions the respective head to a new track. Operation of at least a portion of the adaptive feed forward circuit is suppressed during the SEEK operation. In some embodiments, the at least the portion of the adaptive feed forward circuit is suppressed during the SEEK operation and for a specified time period after the SEEK operation has completed.

In some embodiments of a computer readable storage medium storing one or more programs, instead of including instructions to suppress at least a portion of the adaptive feed forward circuit during a SEEK operation, the one or more programs include instructions to generate a zero error signal for the PES that is received by the adaptive feed forward circuit from the control circuit when the disk drive is performing a SEEK operation.

### BRIEF DESCRIPTION OF THE DRAWINGS

FIG. 1 is a block diagram illustrating a disk drive assembly, according to some embodiments.

FIG. 2 is a block diagram illustrating an adaptive feed forward module, according to some embodiments.

FIG. 3 is a block diagram illustrating an adaptive feed forward module that includes a SEEK detection module, according to some embodiments.

FIG. 4 is a graph illustrating a transient response of an adaptive feed forward module, according to some embodiments.

FIG. 5 is a graph illustrating a transient response of an adaptive feed forward module, according to some embodiments.

FIG. 6 is a graph illustrating a position error signal and a RV signal of an exemplary adaptive feed forward module during and after a SEEK operation, according to some embodiments.

FIG. 7 is a block diagram illustrating an adaptive feed forward module that includes an automatic SEEK detection module, according to some embodiments.

FIG. 8 is a block diagram illustrating an adaptive feed forward module that includes an automatic SEEK detection module, according to some embodiments.

FIG. 9 is a block diagram illustrating a high-pass filter that can be disabled during a SEEK operation, according to some embodiments.

FIG. 10 is a block diagram illustrating an adaptive feed forward module that includes a SEEK input pin, according to some embodiments.

FIG. 11 is a block diagram illustrating an adaptive feed forward module, according to some embodiments.

FIG. 12 is a block diagram illustrating an adaptive feed forward module, according to some embodiments.

FIG. 13 is a block diagram illustrating a control module, according to some embodiments.

FIG. 14 is a flow diagram of a process for generating a compensation signal that compensates for detected rotational vibration events, according to some embodiments.

FIG. 15 is a block diagram illustrating a control module, according to some embodiments.

Like reference numerals refer to corresponding parts throughout the drawings.

### DESCRIPTION OF EMBODIMENTS

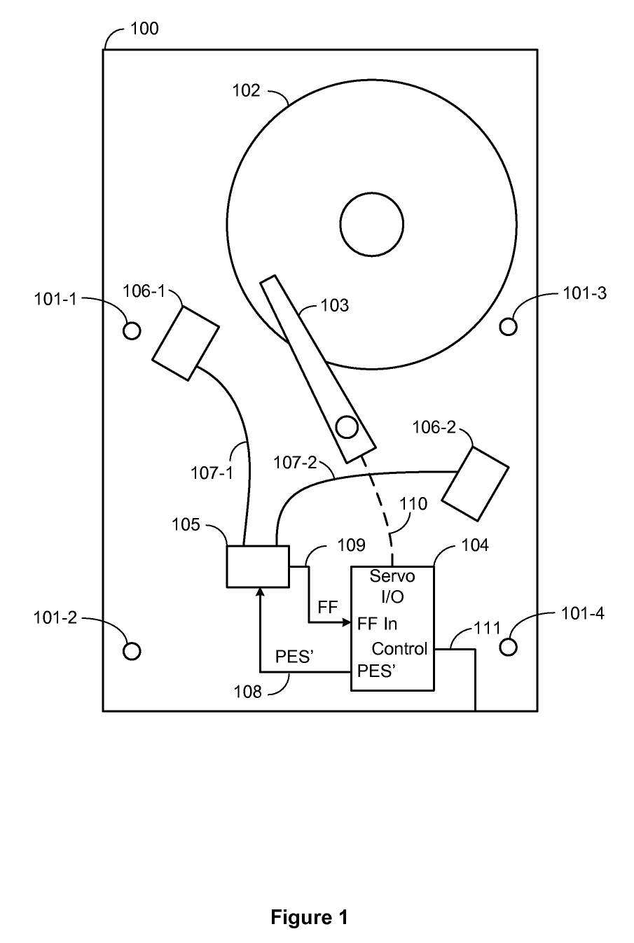

FIG. 1 is a block diagram illustrating a disk drive assembly 100, according to some embodiments. The disk drive assembly 100 includes screws 101, one or more disks 102, one or more heads 103, a control module 104, an adaptive feed forward module 105, accelerometers 106, and traces 107-109. The screws 101 can be used to secure the disk drive assembly to a drive slot (e.g., in a computer system case) or to mounting brackets. The disk drive assembly 100 may include a housing (not shown) that protects the components of the disk drive assembly from dust and physical intrusion. A respective disk in the one or more disks 102 can include one or more tracks onto which a respective head from the one or more heads 103 can read and/or write data.

In some embodiments, the control module 104 generates one or more control signals and a position error signal (PES). In these embodiments, a respective control signal can position a respective head (e.g., the head 103) on a respective track for a respective disk 102. The respective control signal can be based on a control signal from a host system (e.g., a control signal received on traces 111) and a compensation signal from an adaptive feed forward circuit (e.g., the adaptive feed forward module 105). The respective control signal can be transmitted from the control module 104 (e.g., via the servo I/O pin of the control module 104) to the head 103 via traces 110. The PES can indicate an error in a position of the respective head relative to a center of the respective track. In some embodiments, the PES is generated by the control module 105 based on signals received from the head 103. For example, the signals received from the head 103 can indicate the extent to which the head 103 is on-track or off-track. In some embodiments, the head 103 includes circuitry to generate the PES. In these embodiments, the PES is not generated by the control module 104. Instead, the PES is transmitted from the head 103 to the servo I/O pin of the control module 104 via the traces 110.

In some embodiments, the control module 104 transmits the PES (e.g., PES′ via the PES′ pin of the control module 104) to the adaptive feed forward module 105 via the one or more traces 108. In some embodiments, the control module 104 transmits a copy of the PES (e.g., PES′ via the PES′ pin of the control module 104). The copy of the PES can be a replica of the “real” PES. Alternatively, the copy of the PES can be processed. For example, the copy of the PES can be modified to produce a zero error signal. The traces 108 can include wires, conductors in a printed circuit board, and/or any other suitable transmission medium. Alternately, the PES can be transmitted from the control module 104 to the adaptive feed forward module 105 through free space, or an optical fiber, by optical signals.

In some embodiments, the control module 104 is a discrete integrated circuit (IC) chip. In these embodiments, the IC can include a processor (e.g., a central processing unit, a microcontroller, a digital signal processing unit, an application specific integrated circuit, a field programmable gate array, etc.), memory, a computational data path, and/or control logic. The memory of the control module 104 can include data and/or instructions that can be executed by one or more of the processor, the computational data path, and/or control logic.

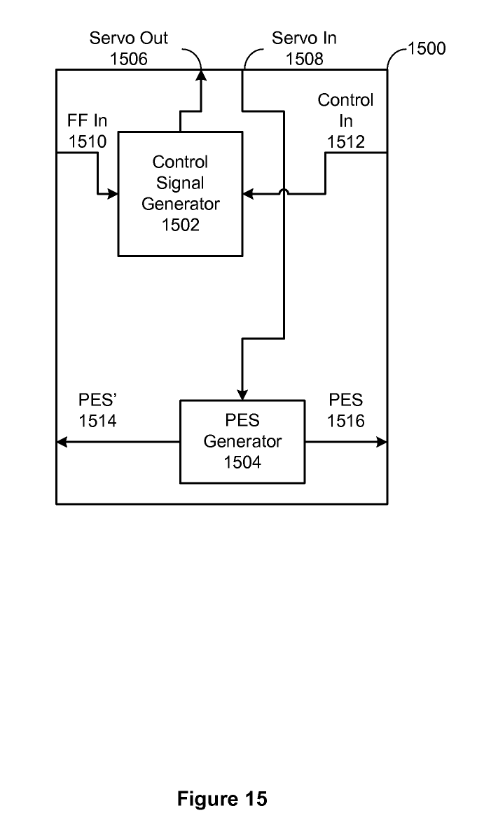

FIG. 15 is a block diagram illustrating a control module 1500, according to some embodiments. The control module 1500 can be the control module 104 illustrated in FIG. 1. The control module 1500 includes a control signal generator 1502 and a PES generator 1504. The control signal generator 1502 can receive a compensation signal from the adaptive feed forward module 105 via FF In 1510 and one or more control signals from the host via Control In 1512. The control signal generator 1502 can then generate a control signal that can position a head (e.g., the head 103) on a specified track on a disk (e.g., the disk 102) based on the compensation signal from the adaptive feed forward module 105 and the one or more control signals from the host. The generated control signal can be transmitted to the head 103 via Servo Out 1506.

In some embodiments, the control module 1500 receives signals from the head 103 that indicate the extent to which the head 103 is on-track or off-track via the Servo In 1508. In these embodiments, the PES generator 1504 generates a PES based on the signals received from the head 103. The PES generator 1504 also generates a modified version (PES′) of the PES, which is transmitted to the adaptive feed forward module 105 via the PES′ output 1514. In particular, the modified PES′ has a predefined, fixed value (e.g., zero) during seek operations. In addition, the modified PES′ may continue to have the predefined, fixed value (e.g., zero) for a specified period (e.g., 60 ms) after completion of the seek operations, during which time transients in the unmodified PES signal settle. Furthermore, the PES generator 1504 can transmit the “real” (e.g., unmodified) PES to other components in the disk drive assembly or to the host via the PES output 1516.

In some embodiments, the adaptive feed forward module 105 is configured to generate a compensation signal (e.g., the “FF” signal in FIG. 1) that compensates for detected rotational vibration (RV) events based on the acceleration signals received from the accelerometers 106 and the PES received from the control module 104. In some embodiments, the PES can be received at a dedicated PES pin on the adaptive feed forward module 105. The acceleration signals can be received from the accelerometers 106 via traces 107. The traces 107 can include wires, conductors in a printed circuit board, and/or any other suitable transmission medium. Alternately, the acceleration signals can be transmitted from the accelerometers 106 to the adaptive feed forward module 105 through free space, or an optical fiber, by optical signals. Due to the spatial separation and positioning of the accelerometers 106, the difference in the accelerometer signals can indicate the amount of RV being experienced by the disk drive assembly 100. In some embodiments, a single RV sensor that can detect RV is used instead of the accelerometers 106.

The adaptive feed forward module 105 can adjust the magnitude of the compensation signal that is fed into the FF input of the control module 104. When properly adjusted, the compensation signal substantially counteracts the displacement of the head 103 caused by RV events, thereby minimizing the magnitude of the PES. In other words, the head 103 remains substantially “on-track” during RV events. Note that the compensation signal can be transmitted from the adaptive feed forward module 105 to the control module 104 via traces 109. The traces 109 can include wires, conductors in a printed circuit board, and/or any other suitable transmission medium. Alternately, the compensation signal can be transmitted from the adaptive feed forward module 105 to the control module 104 through free space, or an optical fiber, by optical signals.

In some embodiments, the compensation signal accounts for self-induced RV events generated by a SEEK operation that repositions the respective head to a new track. In some embodiments, the operation of at least a portion of the adaptive feed forward circuit is suppressed during the SEEK operation.

In some embodiments, the adaptive feed forward module 105 is a discrete integrated circuit (IC) chip. In these embodiments, the IC can include a processor (e.g., a central processing unit, microcontroller, a digital signal processing unit, an application specific integrated circuit, a field programmable gate array, etc.), memory, a computational data path, control logic, and/or combinations of analog and/or digital circuits. The memory of the adaptive feed forward module 105 can include data and/or instructions that can be executed by one or more of the processor, the computational data path, and/or control logic.

Note that the term “modules” as used in this specification (e.g., the control module 104, the adaptive feed forward module 105, etc.) can refer to circuits, discrete IC chips, and/or instructions within memory that can be executed by a processor.

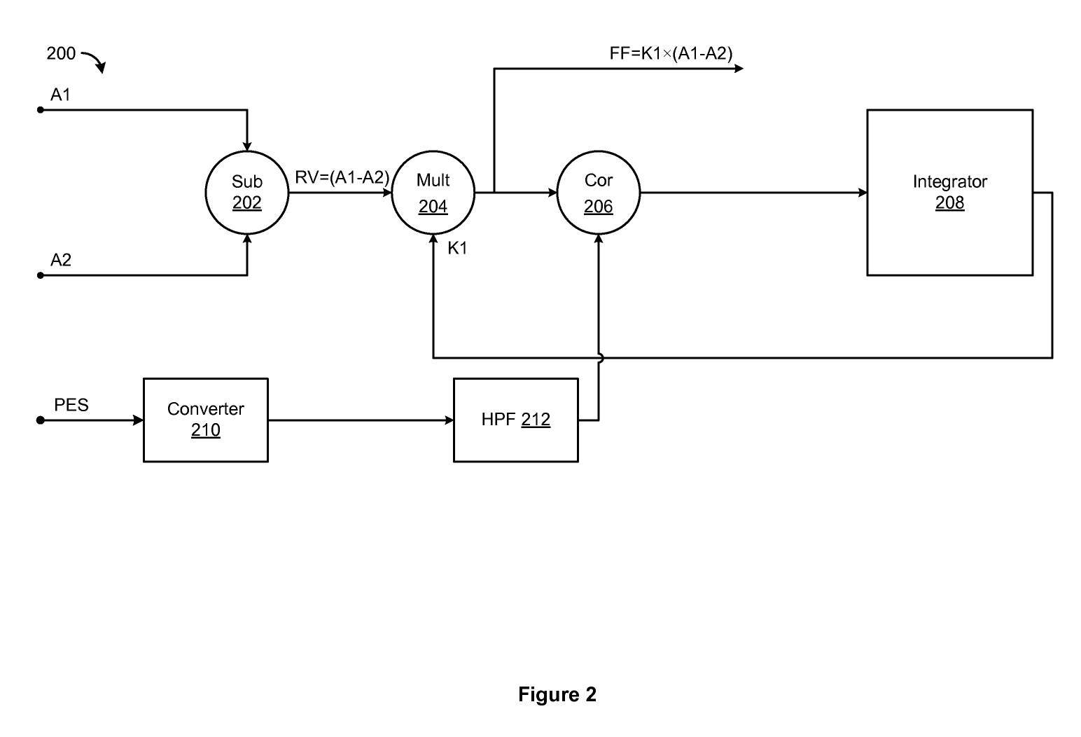

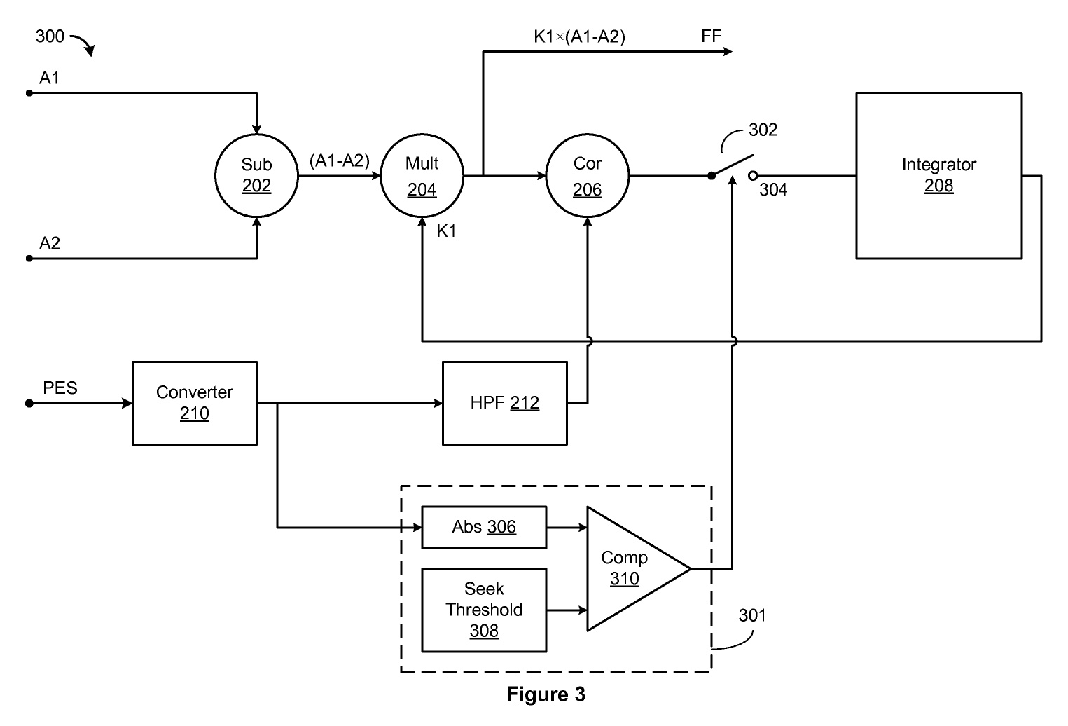

FIG. 2 is a block diagram illustrating an adaptive feed forward module 200, according to some embodiments. The adaptive feed forward module 200 can be the adaptive feed forward module 105 illustrated in FIG. 1. The adaptive feed forward module 200 can include one or more of a subtractor 202, a multiplier 204, a correlator 206, an integrator 208, a converter 210, and/or a high-pass filter 212. Note that the components illustrated in FIG. 2 (and FIGS. 3 and 7-11) are only exemplary and the adaptive feed forward module 200 may include more or fewer components. Also, the components in the adaptive feed forward module 200 may be replaced by components that perform equivalent functions. Furthermore, two or more components in the adaptive feed forward module 200 may be combined into a single component.

In some embodiments, the adaptive feed forward module 200 receives acceleration signals A1 and A2 from two accelerometers (e.g., the accelerometers 106 in FIG. 1). The subtractor 202 can produce an RV signal, which is a difference of the two acceleration signals (e.g., A1−A2). The RV signal can indicate the amount of RV being experienced by a disk drive assembly. In some embodiments, a single RV sensor that can detect RV is used instead of two accelerometers. In these embodiments, the subtractor 202 is not used since the single RV sensor produces the RV signal that indicates the RV experienced by the disk drive assembly.

In some embodiments, the RV signal is multiplied by a scaling factor K1 (also sometimes called a “gain constant” or “gain value”) produced by the integrator 208. The scaling factor scales the RV signal (e.g., K1×(A1−A2)) , which can be fed into the control circuit (e.g., the control module 104 in FIG. 1). While the scaling factor K1 is sometimes called a “gain constant,” it is noted that the scaling factor K1 is not “constant” in value in the adaptive feed forward module 200.

The magnitude of K1 can be determined by an adaptive loop (204, 206, 208) including the correlator 206 and the integrator 208. In some embodiments, one input to the correlator 206 is the gain adjusted RV signal (i.e. K1×(A1−A2)), and another input to the correlator 206 is the PES. However, in some embodiments, the PES is first converted by a converter 210. For example, if the PES is an analog signal, the PES can be converted into a digital signal by the converter 210. Similarly, if the PES is a digital signal, the PES can be converted from a digital signal to a pulse-width modulated (PWM) signal. In some embodiments, the converter 210 is included in the control module 104.

Note that the PES that is generated by the control module 104 can be converted into a PWM signal that is fed to the adaptive feed forward module 105. The adaptive feed forward module 105 can then convert the PWM to a digital signal at the input to the HPF 212 (e.g., by using the converter 210). Thus, the PES applied to the adaptive feed forward module 105 may not be the “real” PES of the disk drive but rather a copy of the PES. The copy of the PES can be modified or processed to exclude the SEEK component of the “real” PES in the control module 106 (e.g., the copy of PES can equal zero when the “real” PES is saturated). As described above with reference to FIGS. 1 and 15, the “real” PES is utilized within the control module 104 for positioning one or more heads of the disk drive. For example, the real PES signal may be combined with the feed forward signal to produce a control signal for the motor that positions the disk drive head.

In some embodiments, the PES is filtered by the high-pass filter 212, which removes DC components of the PES, before the PES is input to the correlator 206. Note that the adaptive feed forward module 200 can convert and filter, convert only, filter only, or not filter and not convert, the PES before the PES is used in the correlator 206. In some embodiments, the correlator 206 is a multiplier.

Note that when the adaptive loop is not properly adapted, the scaling factor K1 is either too large or too small to compensate for the effect of the RV on the head, thus resulting in a non-zero PES as the head moves off-track (off the center of the disk track to which the head has been directed). When properly adapted, K1 properly scales the compensation signal to compensate for the effect of RV on the head, thus resulting in a zero PES, or a PES that remains very close to zero while the disk drive assembly experiences RV.

Adaptation can be accomplished by generating a correlation signal between the PES and the RV signal, integrating this correlated signal, and using the output of the integrator as the gain value (scaling factor) K1. When properly adapted, PES and the output of the correlator 206 go to zero during RV events. A zero output for the correlator 206 stops the output of the integrator 208 from changing. Thus, K1 is held at a fixed value. Once properly adapted, new RV events (which cause changes in the RV signal) do not result in changes in K1. K1 remains substantially unchanged because the PES remains at or very close to zero during such RV events, and the PES remains at or very close to zero during RV events because the feed forward (FF) signal compensates for the RV. Stated in another way, any change in K1 caused by RV events is small and ephemeral, with K1 substantially returning to its prior value at the end of each RV event.

As previously mentioned, the PES signal can be processed by a high-pass filter 212 prior to being applied to the input of the correlator 206. The high-pass filter 212 removes any DC offset from the PES. If PES contains a DC offset that is not removed, the adaptive loop (204, 206, 208) may not converge on the correct value of K1 because the correlator 206 may produce an output even when the head is centered on track. K1 only stops changing if the PES goes to zero and this condition may not occur if there is a DC offset in the PES.

In various embodiments, the PES signal is an analog signal, a digital signal, or a pulse-width modulated (PWM) signal. In some embodiments, the adaptive feed forward module is implemented with digital logic. In these embodiments, the PES signal must be converted to a digital representation. The converter 210 can convert the PES to an appropriate format. Regardless of the type of the PES, DC offsets are a concern that must be removed. Typical RV signals are in a frequency range of 100 Hz to 2 Khz. Thus, setting the corner frequency of the high-pass filter 212 to 10 Hz (e.g., a minimum of a factor of 10 below the lowest frequency of interest) or lower can be sufficient to remove the DC offset while still passing the frequencies of interest.

During a track SEEK operation, the head (e.g., the head 103) moves off of its present track and moves to a new track. This head movement is reflected in a large change in the PES. In fact, it is possible for the PES to “saturate” and go to its most positive or most negative value. Note that the PES can be bi-directional about zero. If an RV event occurs while the drive is performing a SEEK operation, the output of the correlator 206 can be non-zero and can produce a change in K1 even if the adaptation loop was previously adapted to the correct K1 value. Thus, in some embodiments, adaption is disabled during a SEEK operation.

RV compensation following a SEEK operation can be important when the RV event is self-induced by the SEEK operation. SEEK-induced RV events can degrade the settling time on the destination track, which in turn increase latency and ultimately reduces the throughput of the drive.

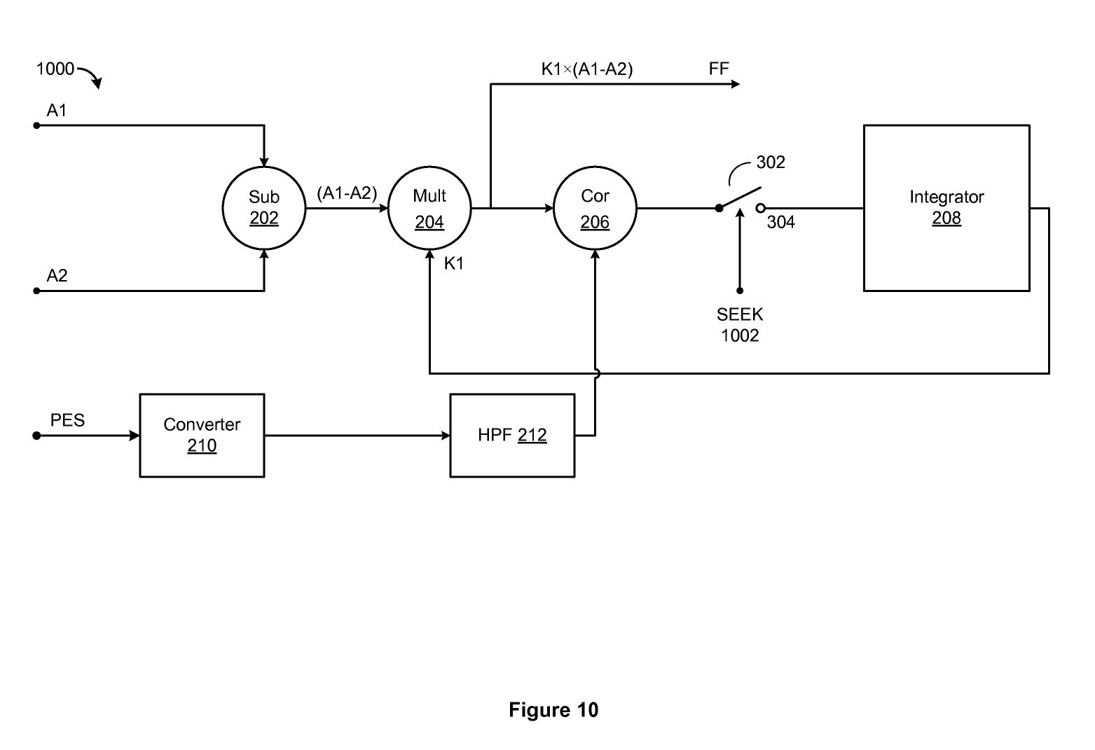

FIG. 3 is a block diagram illustrating an adaptive feed forward module 300, according to some embodiments. The adaptive feed forward module 300 includes components similar to the adaptive feed forward module 200 in FIG. 2, thus, only the differences are described. The adaptive feed forward module 300 includes a switch 302 and a SEEK detection module 301. The switch 302 can be interposed between the correlator 206 and the integrator 208. During a SEEK operation, the switch 302 is opened and therefore a zero signal level (not shown) is applied to the input of the integrator 208. The switch 302 can be controlled by a SEEK signal, which is used to open and to close the switch 302 during a SEEK operation. The SEEK signal can be received from an external SEEK pin (e.g., the SEEK input pin 1002 in FIG. 10) or can be generated by the SEEK detection module 301.

In some embodiments, the SEEK detection module 301 includes an absolute value module 306, a seek threshold value 308 and a comparator 310. The absolute value module 306 performs an absolute value function on the PES (or the converted PES), which is then compared to the SEEK threshold value 308. The SEEK threshold value 308 may be stored in a register or other circuit (e.g., a counter) that is either internal or external to the SEEK detection module 301. Output of the comparator 310 can be used to open the switch 302 when the PES signal is above the SEEK threshold value and can be used to close the switch 302 (e.g., to position 304) otherwise. In some embodiments, the SEEK threshold value is set to a specified high value. The specified high value can be chosen so that PES values above the specified high value correspond to PES values that occur only during a SEEK operation.

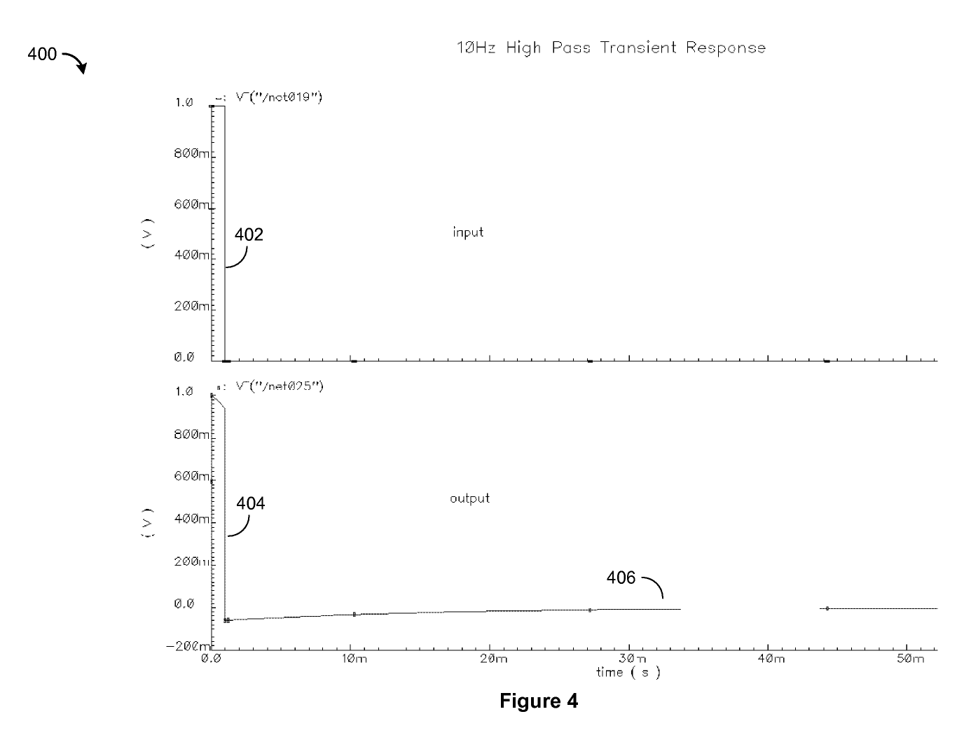

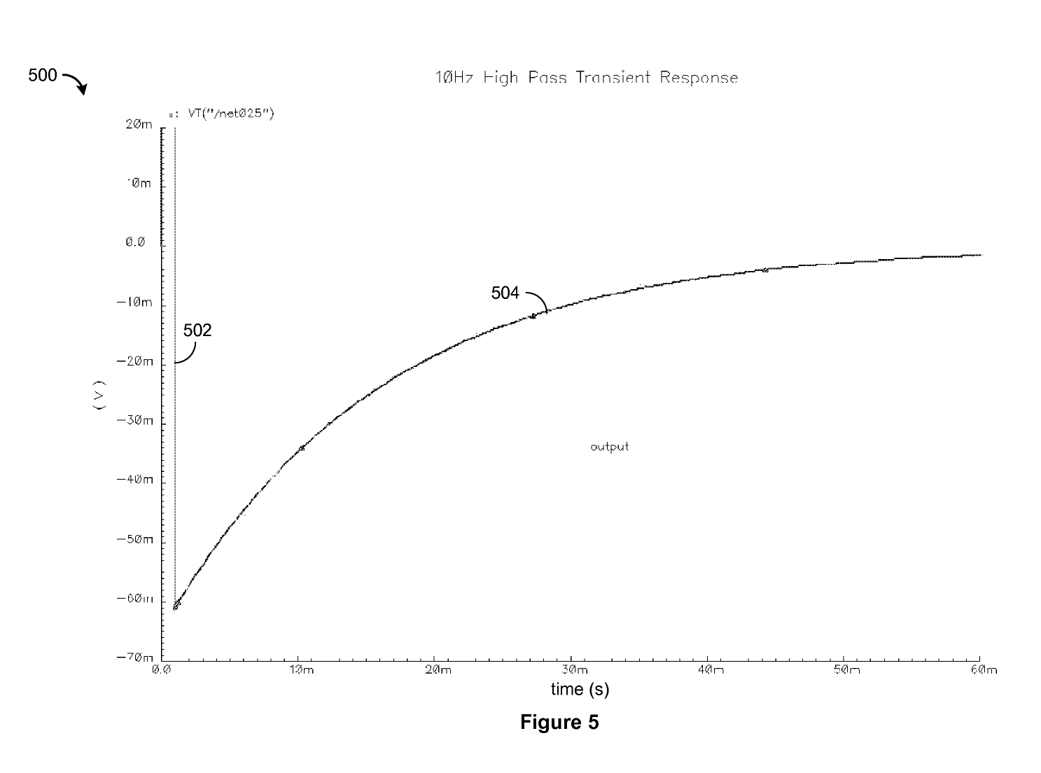

Unfortunately, in the adaptive feed forward module 300, a large PES transition may produce a transient response from the high-pass filter 212, which needs time to settle. For example, if the high-pass filter 212 has a 10 Hz pole, then the PES transient at the output of the high-pass filter 212 can take approximately 5/(10 Hz*2*π)=80 ms to settle after an input transition. An example of this settling characteristic is shown in the graphs 400 and 500 in FIGS. 4 and 5, respectively. Note that FIGS. 4 and 5 are based on simulations (using the SPICE circuit simulation program) of a single pole 10 Hz high pass filter. As illustrated in FIG. 4, an input pulse 402 is placed at the input of the high-pass filter 212. The output of the high-pass filter 212 includes a response 404 to the input pulse 402 and a recovery tail 406, which exponentially returns to the steady state (e.g., zero). FIG. 5 is a zoomed-in view of output response illustrated in FIG. 4. In FIG. 5, response 502 5 to the input pulse 402 corresponds to the response 404 in FIG. 4. Similarly, a recovery tail 504 corresponds to the recovery tail 406 in FIG. 4. Note that FIGS. 4 and 5 illustrate a long recovery tail at the output of the high-pass filter 212.

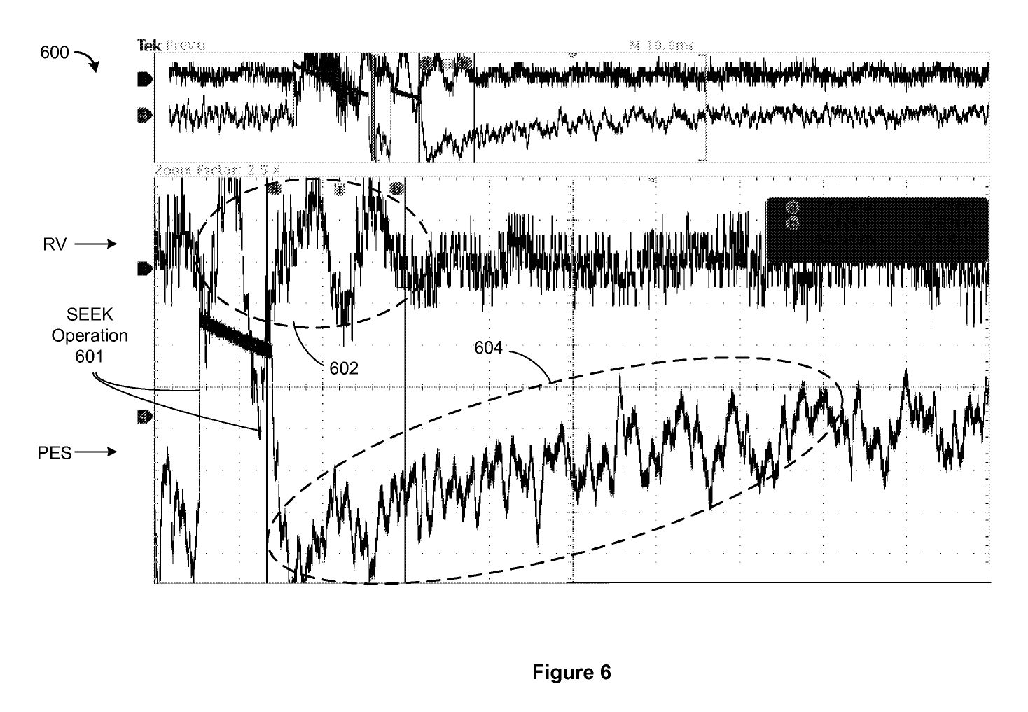

Since K1 adaptation looks at the correlation between the PES and the RV, the recovery tail on the PES (e.g., at the output of the high-pass filter 212) can generate an erroneous correlation with the RV generated by the SEEK. In other words, assume that K1 is adapted and properly compensating RV events. In this case, an RV event does not produce a PES since the compensation signal keeps the head (e.g., the head 103 in FIG. 1) on-track and minimizes the PES even if the RV is self-induced (e.g., from a SEEK operation). However, if the PES shows an apparent error due to the recovery tail (e.g., the recovery tail 406 or 504 in FIGS. 4 and 5, respectively), then the presence of the self-induced RV and the recovery tail generate a correlated output that produces an erroneous change in the K1 value. FIG. 6 is a graph 600 illustrating a PES and a RV signal of an adaptive feed forward module (e.g., the adaptive feed forward modules 300 in FIG. 3) during and after a SEEK operation 601, according to some embodiments. Note that FIG. 6 illustrates oscilloscope signal traces for a disk drive. The time alignment of the self-induced RV 602 generated by the SEEK operation 601 and the PES recovery tail 604 can cause a divergence of K1. Note that in FIG. 6, the SEEK operation 601 occurs over a time period and produces both a large PES and self-inducted RV.

The divergence of K1 (from its previously and properly determined value) means that RV compensation may be compromised. Note that K1 tends to diverge in the same direction (e.g., to a lower value) regardless of the direction of the SEEK operation. A SEEK operation that causes a head at an inner track to be repositioned to an outer track produces a self-induced RV signal that is 180 degrees different than a SEEK operation that cases a head at an outer track to be repositioned to an inner track. Furthermore, the polarity of the recovery tail depends on the direction of the SEEK. Thus, the product of the self-induced RV and the PES recovery tail has the same polarity for SEEK operations in both directions, which causes the value of K1 to move in the same direction in response to SEEK operations in both directions.

In summary, the divergence of K1 (from its previously and properly determined value) is a result of the transient response of the high-pass 212 filter between the PES input and the correlator 206. Thus, several techniques can be used to address this problem.

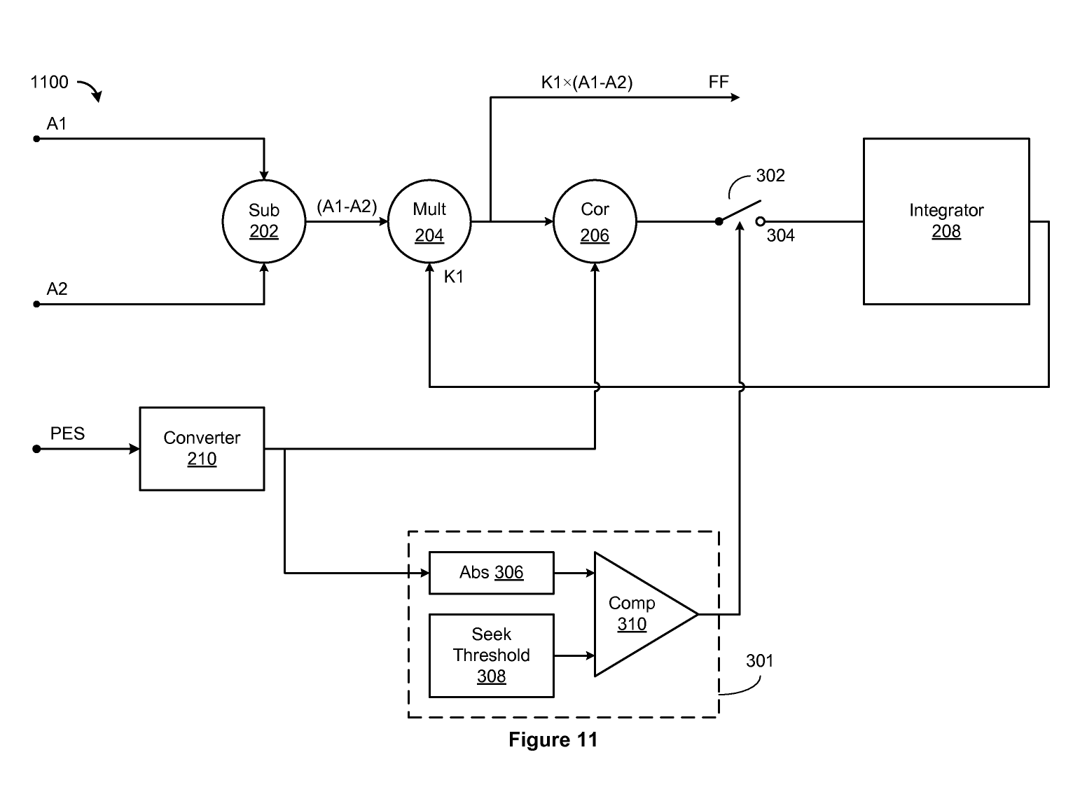

In some embodiments, the high-pass filter between the PES input and the correlator is removed. These embodiments are illustrated in FIG. 11, which is a block diagram illustrating an exemplary adaptive feed forward module 1100. The adaptive feed forward module 1100 is similar to the adaptive feed forward module 300 except that the high-pass filter 212 has been removed. Eliminating the high-pass filter may not be a practical solution because small DC offsets in the PES can cause a divergence of the adaptive loop. Even if the actual PES is centered at zero, translating the PES to a pulse-width modulation (PWM) signal (e.g., to be presented to the adaptive loop), can introduce a duty cycle error (e.g.,. from different rise and fall times of the PWM signal), which in turn can cause a DC offset.

In some embodiments, the pole frequency of the high-pass filter is adjustable, and is selectively reduced from a first predefine frequency (used when SEEK operations are not being performed). For example, the pole frequency can be reduced from 10 Hz to a predefined lower frequency (e.g., 5 Hz) during SEEK operations. However, these embodiments may be impractical because a digital signal processor that generates the high-pass filter pole frequency (e.g., for a digital high-pass filter) may already be operating at a frequency (e.g., 78 Khz) that is orders of magnitude faster than 10 Hz. Thus, generating a low frequency pole requires numerical representations that have a large number of bits of precision. This precision is necessary to accurately position the pole near the unit circle of the Z-plane.

Furthermore, the transfer function of the high-pass filter is of the form:

$$\frac{G ( 1 - {z}^{- 1} )}{1 - {Az}^{- 1}} \qquad ( 1 )$$

Thus, the pole is located at z=A. To maintain stability the pole must be inside the unit circle. For a low cutoff frequency/pole, the normalized cutoff frequency is directly proportional to the distance from A to a point which is on the unit circle. For example, the normalized 3 db frequency of a high-pass filter with a 10 Hz pole is π×10/78e3=0.4e-3, A is roughly 0.9995. Thus, the high-pass filter pole must be very close to the stability border of the unit circle to achieve this low cutoff frequency. Also, a penalty incurred in placing poles close to the unit circle is that the noise power is increased at the filter output. Quantization noise is inherent in the fixed point implementation of digital filters. As the pole location A is shifted closer to 1, a linearized model of quantization noise indicates the noise power at the output increases in proportion to 1/(1−A²). Also, some input signals can cause non-linear effects that result in a noise magnitude term proportional to 1/(1−A). Both of these noise terms concentrate their power at the output at DC. They operate to negate the purpose of the high-pass filter, which is to remove the DC component in the PES signal. Thus, these noise terms limit the range in which the cutoff frequency can be reduced.

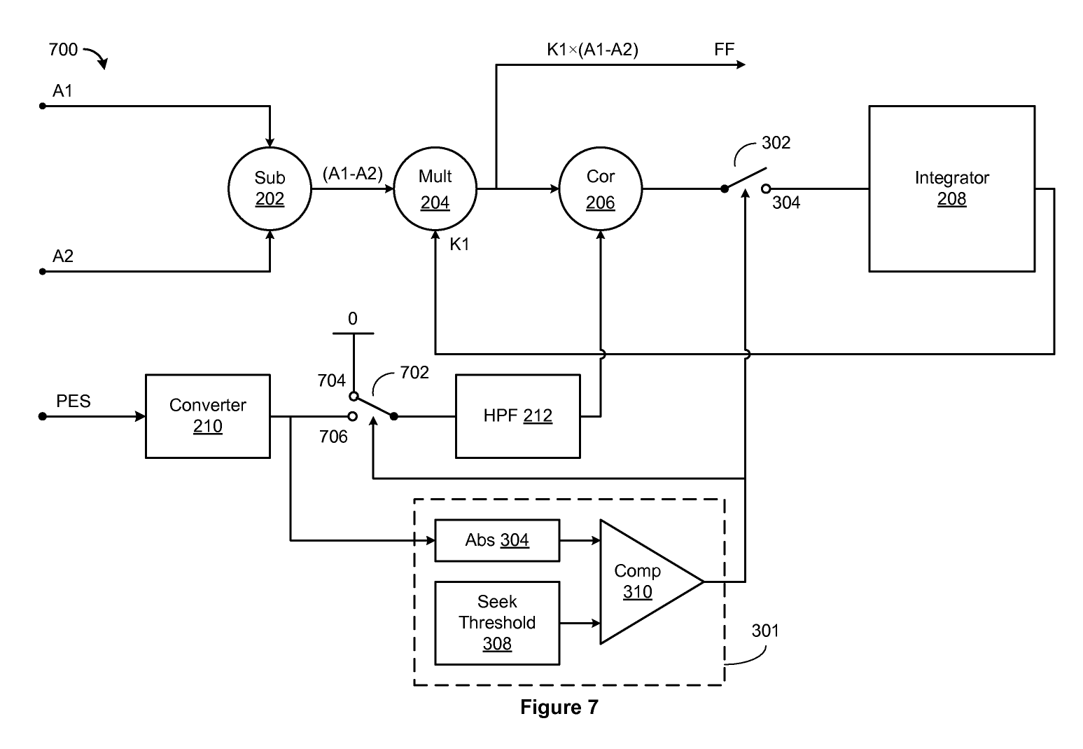

In some embodiments, the input to the high-pass filter is disabled (e.g., disconnected from the PES) when a SEEK operation is detected. In these embodiments, the input to the high-pass filter can be re-enabled (e.g., reconnected to the PES) after the SEEK operation is completed. In some embodiments, the input to the high-pass filter is re-enabled a specified time after the SEEK operation is completed. These embodiments are illustrated in FIG. 7, which is a block diagram illustrating an example of an adaptive feed forward module 700. The adaptive feed forward module 700 is similar to the adaptive feed forward module 1100 in FIG. 11, thus, only the differences are discussed. The adaptive feed forward module 700 includes a switch 702 interposed between the converter 210 and the high-pass filter 212. The switch 702 can be controlled by the output of the SEEK detection module 301 (e.g., the output of the comparator 310). When the absolute value of the PES exceeds the SEEK threshold value 308, the output of the comparator 310 opens the switch 302 and sets the switch 702 into an open position 704. With the switch 702 in the open position 704, the PES is removed from the input of the high-pass filter 212. In some embodiments, the input to the high-pass filter 212 is connected to a zero signal level when the switch 702 is open. This zero signal level can simulate a zero error signal (e.g., a zero PES). For example, if the PES is a PWM signal, the zero signal level can be a 50% duty cycle PWM signal.

If the on-track level of the real PES is centered around a zero signal level, these embodiments (shown in FIG. 7) can prevent large PES transients, which can occur during a SEEK operation, from being applied to the high-pass filter input. These embodiments can also prevent the recovery tail from occurring at the output of the high-pass filter 212. However, there is no guarantee that the PES is exactly centered on a zero signal level at any particular instant in time (e.g., immediately before a SEEK operation). Thus, switching the switch 702 from a closed position 706 (e.g., for conveying PES to the high pass filter 212) to the open position 704 (e.g., for conveying the zero signal level to the high pass filter 212) can itself create a transient response which can have an associated recovery tail. Note that the closer the value of the PES is centered on the zero signal level immediately prior to the SEEK operation, the smaller the amplitude and duration of the high pass filter's recovery will be. In some embodiments, the control signal for the switches 702 and 302 can be from an external input pin (e.g., a SEEK input pin−not shown) instead of from the SEEK detection module 301. In these embodiments, the SEEK detection module 301 is not included in the adaptive feed forward module 700.

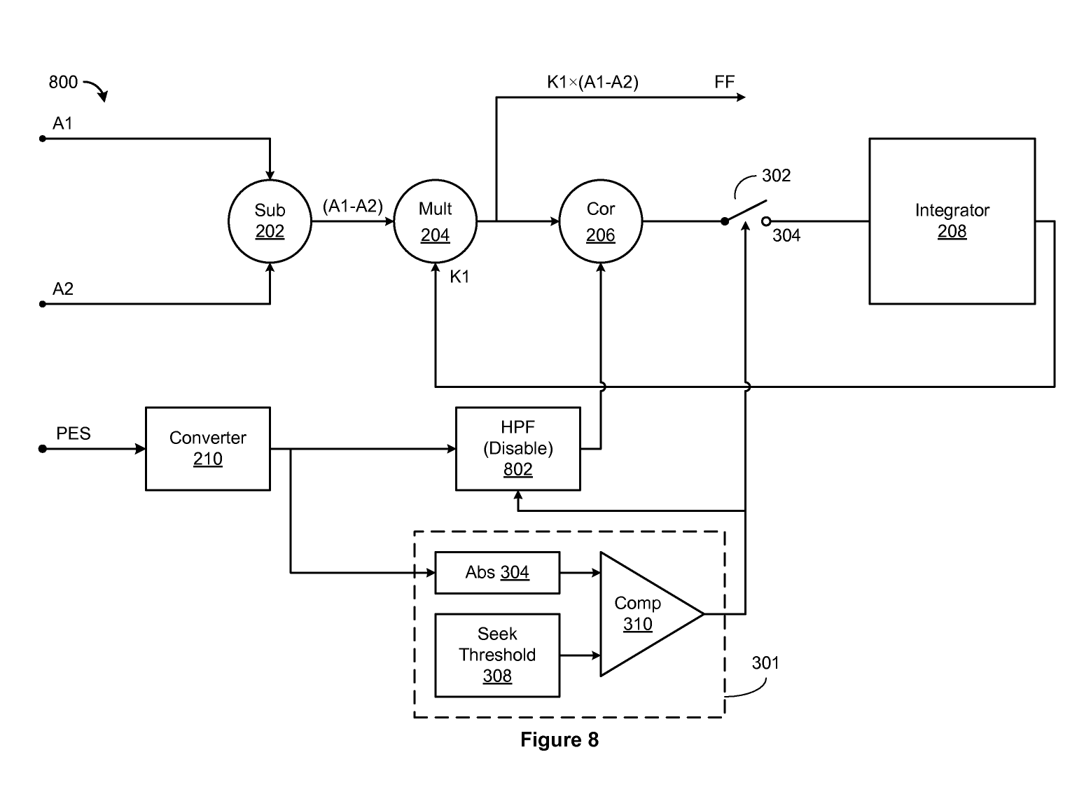

In some embodiments, the high-pass filter is disabled when a SEEK operation is detected. Note that unlike the embodiments described above with reference to FIG. 7, in these embodiments, the PES is not removed from the input of the high-pass filter. As illustrated in FIG. 8, a high-pass filter 802 in a respective embodiment of the adaptive feed forward module 800 can be disabled based on the output of the SEEK detection circuit (or a SEEK signal from a SEEK input pin). In some embodiments, disabling the high-pass filter 802 includes disabling the filter update. Note that in these embodiments, the high-pass filter 802 continues to operate, but the state of the high-pass filter is held at the point just before the disable signal is asserted, as described in more detail below.

In some embodiments, the high-pass filter is re-enabled when the SEEK operation is completed. In some other embodiments, the high-pass filter is re-enabled a specified time after the SEEK operation is completed. In these embodiments, the recovery tail can be reduced or eliminated. Note that when the high-pass filter 802 is disabled, the operation of the high-pass filter can be non-linear, but this non-linear operation does not have an impact on the DC filtering properties of the high-pass filter 802.

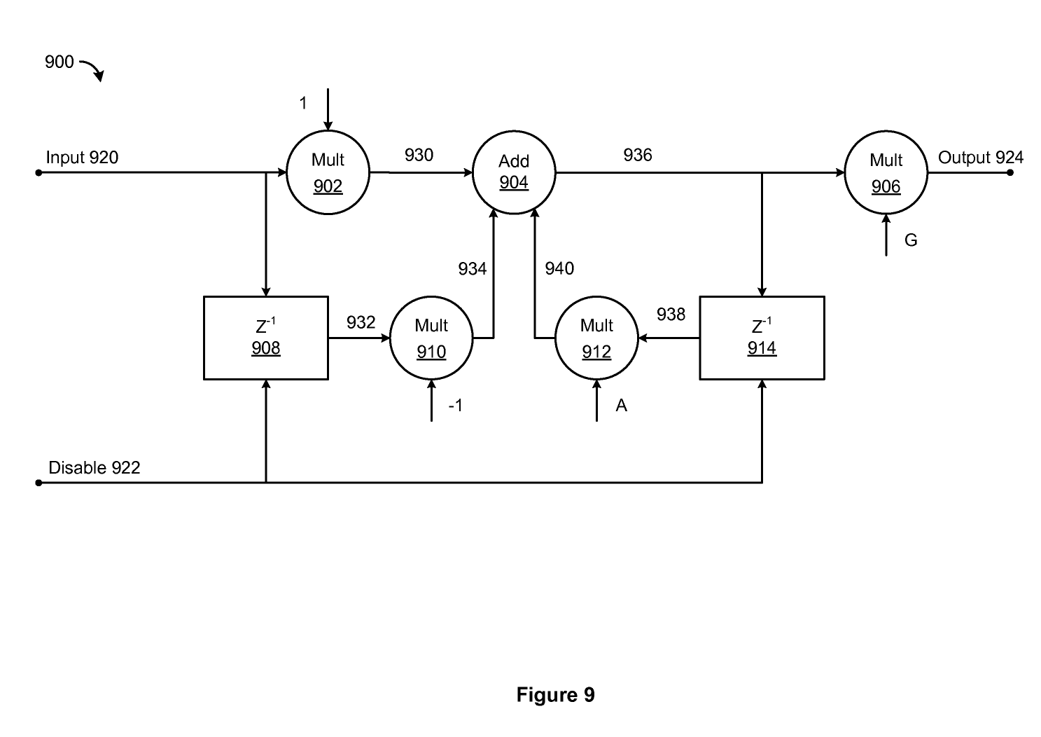

FIG. 9 is a block diagram illustrating a high-pass filter 900 that can be disabled (or, perhaps more accurately, partially disabled) during a SEEK operation, according to some embodiments. The high-pass filter 900 can be the high-pass filter 802 in FIG. 8. The high-pass filter 900 includes multipliers 902, 906, 910, and 912, an adder 904, and delay blocks 908 and 914. The multiplier 902 is configured to multiply an input signal 920 by 1 to produce a signal 930. The delay block 908 is configured to delay the input signal 920 to produce a signal 932. The multiplier 910 is configured to multiply the signal 932 by −1 to produce the signal 934. The adder 904 is configured to add the signal 930, the signal 943, and a signal 940 to produce a signal 936. The delay block 914 is configured to delay the signal 936 to produce the signal 938. The multiplier 912 is configured to multiply the signal 938 by A to produce the signal 940. The multiplier 906 is configured to multiply the signal 936 by G to produce an output signal 924. Note that the variables A and G are specified in Equation (1) above.

When used as the high pass filter 802, the input 920 is the PES (or a related signal, derived from the PES), and the output 924 is the filtered PES input to the correlator 206 (see FIG. 8, or FIG. 3). During a SEEK operation, a disable signal 922 is activated, which disables delay blocks 908 and 914. For example, the disable signal 922 may be a SEEK detection signal produced by a seek detector circuit 301 (FIG. 8, FIG. 3), as described above with reference to FIGS. 3 and 8. While disabled, the outputs of delay blocks 908 and 914 remain constant, at the last output values of those delay blocks prior to the disable signal 922 being activated. Thus, the high pass filter 900 continues to operate, but the output of the filter is a gain G multiplied by the input signal plus a fixed offset (from the disabled delay blocks 908, 914).

In some embodiments, the PES input to the adaptive feed forward module (e.g., the adaptive feed forward module 200 in FIG. 2) is set to a zero signal level by the control module (e.g., the control module 104 in FIG. 1). In these embodiments, the control module “knows” when a SEEK operation occurs and when it completes because the SEEK command is issued to the control module to move the heads to specified tracks. Thus, in these embodiments, the control module can modify the PES signal transmitted to the adaptive feed forward module and force the PES to a zero level. For example, if the PES is a PWM signal, the PWM duty cycle can be set to 50% to produce a zero signal level. Note that although the PES may be a large value during a SEEK operation, the control module replaces the real value of the PES with a zero signal level during the SEEK operation. Since the adaptive feed forward module never sees the real PES signal, the high-pass filter does not respond to a SEEK operation. Thus, the recovery tail is not present. However, there is no guarantee that the value of the PES is exactly centered on zero prior to the SEEK operation. Thus, forcing the PES to a particular signal level can create a transient response which may have an associated recovery tail. Note that the amplitude of the recovery tail is proportional to the amplitude of the PES signal level prior to the SEEK operation, and therefore the smaller the amplitude of PES signal level (e.g., the closer it is to zero) prior to the SEEK operation the smaller the amplitude of the recovery tail.

In some embodiments, a SEEK input pin is added to the control module to indicate when a SEEK operation is being performed. FIG. 10 is a block diagram illustrating an adaptive feed forward module 1000 that includes a SEEK input pin 1002, according to some embodiments. In these embodiments, the control module (e.g., the control module 104 in FIG. 1) asserts a SEEK signal on the SEEK input pin 1002 that indicates that a SEEK operation is occurring. In some embodiments, the SEEK signal is asserted for the duration of the SEEK operation plus a specified period of time after the SEEK operation completes. When the SEEK signal is asserted, the switch 302 opens, removing the output of the correlator 206 from the input to the integrator 208. In some embodiments, the input to the integrator 208 is connected to a zero signal level (not shown) during a SEEK operation. Thus, the high-pass filter 212 continues to the see the actual PES (e.g., the PES responds to the SEEK event) and the high-pass filter 212 still produces a recovery tail. In these embodiments, the SEEK signal is asserted sufficiently long after the SEEK operation completes to allow time for the recovery tail of the high-pass filter 212 to settle (e.g., approximately 60 ms for a 10 Hz high-pass filter pole). However, in these embodiments, the adaptive feed forward module 1000 does not adapt to self-induced RV signals resulting from the SEEK operation, which primarily occurs just after the SEEK operation completes. In other words, these RV events are masked by disabling adaptation during the time it takes the recovery tail to settle.

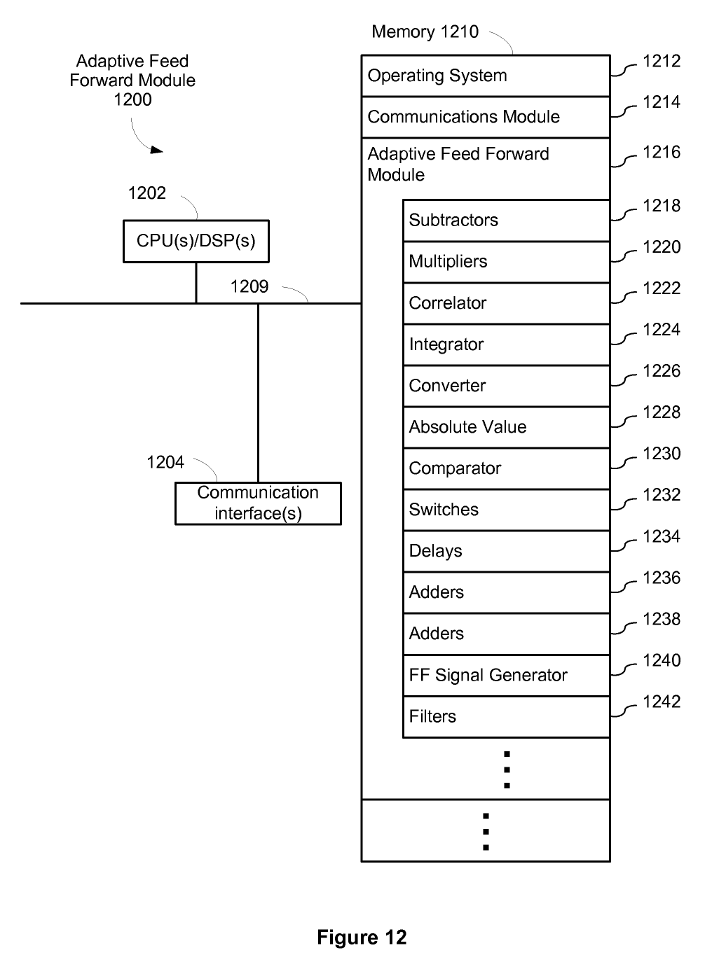

FIG. 12 is a block diagram illustrating an adaptive feed forward module 1200 in accordance with one embodiment of the present invention. The adaptive feed forward module 1200 is an embodiment of the adaptive feed forward module 105 illustrated in FIG. 1. The adaptive feed forward module 1200 includes one or more processors 1202 (e.g., CPUs, DSPs, etc.), one or more communications interfaces 1204, memory 1210, and one or more communication buses 1209 for interconnecting these components. The communication buses 1209 may include circuitry (sometimes called a chipset) that interconnects and controls communications between system components, which may include components such as a digital-to-analog converter (DAC) and/or serial peripheral interface (SPI), in addition to the aforementioned one or more processors 1202 and memory 1210. The memory 1210 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 1210 may optionally include one or more storage devices remotely located from the CPU(s) 1202. The memory 1210, or alternately the non-volatile memory device(s) within the memory 1210, comprises a computer readable storage medium. In some embodiments, the memory 1210 stores the following programs or modules (for execution by the one or more processors 1202) and data structures, or a subset thereof: an operating system 1212, a communication module 1214, and an adaptive feed forward module 1216.

The operating system 1212 can include procedures for handling various basic system services and for performing hardware dependent tasks. The communication module 1214 can be used for connecting the adaptive feed forward module 1200 to other components via the one or more communication interfaces 1204 (e.g., wired or optical) and one or more communication media (e.g., wires, traces, optical fibers, etc.) or communication networks, such as the Internet, other wide area networks, local area networks, metropolitan area networks, and so on. In some embodiments, the communications interface 1204 includes buffers, pins, one or more DACs, an SPI, an SPI bus controller, a PWM to digital number converter, and a digital number to PWM converter, or a subset of such components. Note that the SPI can include any interface that includes memory/registers and that is synchronously (e.g., via a clock signal) addressed and accessed.

The adaptive feed forward module 1216 can be any one of the adaptive feed forward modules described above. In some embodiments, the adaptive feed forward module 1216 includes for one or more of: subtractors 1218, multipliers 1220, a correlator 1222, an integrator 1224, a converter 1226, an absolute value module 1228, a comparator 1230, switches 1232, delays 1234, adders 1236, a high-pass filter 1238, a feed forward signal generator 1240, and filters 1242. The subtractors 1218 can subtract two or more signals. The multipliers 1220 can multiply two or more signals. The correlator 1222 can correlate two or more signals. In some embodiments, the correlator 1222 is a multiplier. The integrator 1224 can integrate signals. The converter 1226 can convert signals represented in one format to another format. For example, the converter 1226 can convert signals represented as analog signals to signals represented in pulse-width modulated (PWM) signals. The comparator 1230 can compare two or more signals and report whether the two or more signals meet a specified condition. For example, the comparator 1230 can compare a first signal and a second signal and report whether the first signal exceeds the second signal. The switches 1232 can selectively route signals (e.g., analog or digital signals) to different locations and/or modules. The delays 1234 can delay signals. The adders 1236 can add two or more signals. The high-pass filter 1238 can substantially filter out DC components of a signal, but substantially pass non-DC components of a signal. In some embodiments, the high-pass filter 1238 is a digital high-pass filter. In some embodiments, the high-pass filter 1238 can be disabled or partially disabled, as described above with respect to FIG. 9. The feed forward signal generator 1240 can generate a feed forward signal as described above with respect to FIGS. 2-3 and 7-11 above. The filters 1242 can provide signal filtering. For example, the filters 1242 can include a low pass filter that can filter out higher frequency signals (e.g., ˜20 KHz resonant peaks) that can be produced by the accelerometer. Similarly, an output filter at the feed forward signal output can be used to compensate for the disk drive control module (e.g., servo loop's) frequency and phase response. These modules (or instructions for the modules) can be combined in the manner described with respect to FIGS. 2-3 and 7-11 above to implement an adaptive feed forward module that generates a feed forward signal that can compensate for self-induced RV (e.g., from a SEEK operation).

Each of the above identified elements may be stored in one or more of the previously mentioned memory devices, and corresponds to a set of instructions for performing a function described above. The set of instructions can be executed by one or more processing units (e.g., the one or more CPUs/DSPs 1202). The above identified modules or programs (i.e., sets of instructions) need not be implemented as separate software programs, procedures or modules, and thus various subsets of these modules may be combined or otherwise re-arranged in various embodiments. In some embodiments, the memory 1210 may store a subset of the modules and data structures identified above. Furthermore, the memory 1210 may store additional modules and data structures not described above.

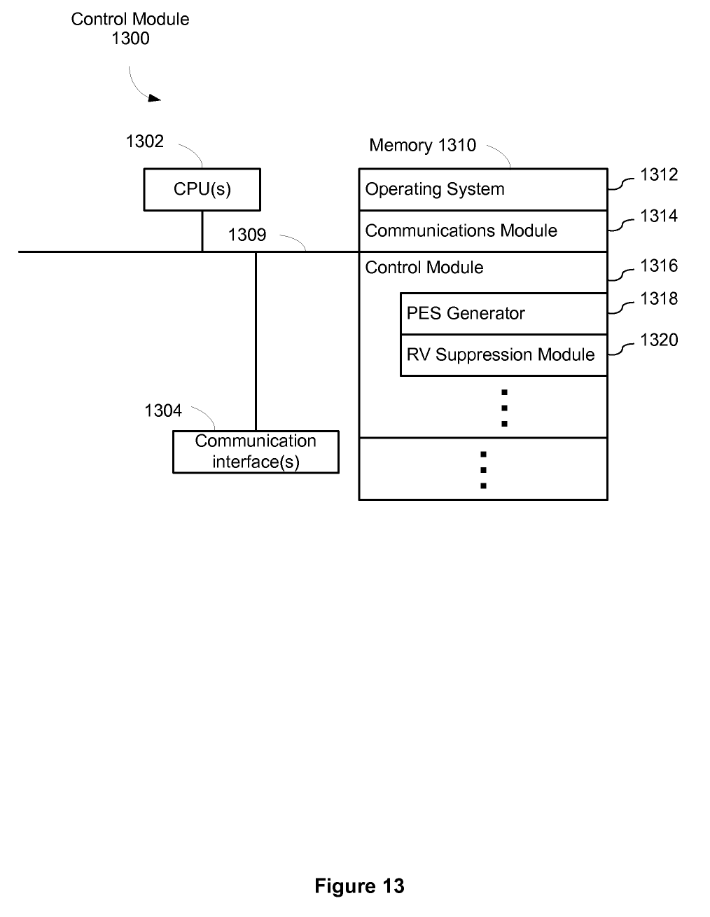

FIG. 13 is a block diagram illustrating a control module 1300 in accordance with one embodiment of the present invention. For example, the control module 1300 can include the control module 104 illustrated in FIG. 1. The control module 1300 includes one or more processors 1302 (e.g., one or more CPU's, DSPs, etc.), one or more communications interfaces 1304, memory 1310, and one or more communication buses 1309 for interconnecting these components. The communication buses 1309 may include circuitry (sometimes called a chipset) that interconnects and controls communications between system components. The memory 1310 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 1310 may optionally include one or more storage devices remotely located from the CPU(s) 1302. The memory 1310, or alternately the non-volatile memory device(s) within the memory 1310, comprises a computer readable storage medium. In some embodiments, the memory 1310 stores the following programs or modules (for execution by the one or more processors 1302) and data structures, or a subset thereof: an operating system 1312, a communication module 1314, and a control module 1316.

The operating system 1312 can include procedures for handling various basic system services and for performing hardware dependent tasks. The communication module 1314 can be used for connecting the control module 1300 to other components via the one or more communication interfaces 1304 (e.g., wired or optical) and one or more communication media (e.g., wires, traces, optical fibers, etc.) or communication networks, such as the Internet, other wide area networks, local area networks, metropolitan area networks, and so on. In some embodiments, the communications interface 1204 includes buffers, pins, one or more DACs, an SPI, an SPI bus controller, a PWM to digital number converter, and a digital number to PWM converter, or a subset of such components. Note that the SPI can include any interface that includes memory/registers, and that is synchronously (e.g., via a clock signal) addressed and accessed.

In some embodiments, the control module 1316 includes one or more of: a PES generator 1318 and a RV suppression module 1320. The PES generator 1318 can be configured to generate a PES proportional to the degree to which a head is off-track. As discussed above, in some embodiments the generated PES may be suppressed or replaced with a predefined signal (e.g., a zero value) during SEEK operations, and optionally for a predefined period of time (e.g., 60 ms) after the completion of each SEEK operation. The RV suppression module 1320 can be configured to receive a feed forward signal that can be used to reposition a head to compensate for RV events. The PES produced by control module 1300 is an output conveyed to an adaptive feed forward module, and perhaps other modules as well, as described above. The feed forward signal input signal, received from an adaptive feed forward module, is conveyed to the control module 1316 as described above.

Each of the above identified elements may be stored in one or more of the previously mentioned memory devices, and corresponds to a set of instructions for performing a function described above. The set of instructions can be executed by one or more processing units (e.g., the one or more CPUs/DSPs 1302). The above identified modules or programs (i.e., sets of instructions) need not be implemented as separate software programs, procedures or modules, and thus various subsets of these modules may be combined or otherwise re-arranged in various embodiments. In some embodiments, the memory 1310 may store a subset of the modules and data structures identified above. Furthermore, the memory 1310 may store additional modules and data structures not described above.

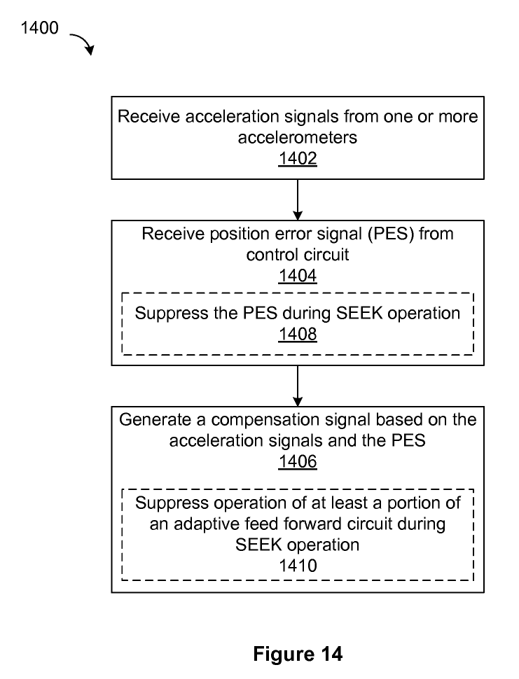

FIG. 14 is a flow diagram of a process 1400 for generating a compensation signal that compensates for detected rotational vibration events, according to certain embodiments of the invention. In some embodiments, the process 1400 is governed by instructions that are stored in a computer readable storage medium and that are executed by one or more processors. Each of the operations shown in FIG. 14 may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors or state machines. In other embodiments, process 1400 is performed by analog and/or digital circuitry that does not include one or more programmed processors.

The process 1400 is described with respect to an adaptive feed forward module for the sake of clarity. However, the process 1400 can be performed in other modules and systems. Referring to FIG. 14, the adaptive feed forward module receives from one or more accelerometers acceleration signals that are used to detect rotational vibration (RV) events on a disk drive (1402). The adaptive feed forward module receives from a control circuit a position error signal (PES) that indicates an error in a position of a respective head relative to a center of a respective track of the disk drive (1404). The adaptive feed forward module then generates a compensation signal based on the acceleration signals and the PES (1406). In some embodiments, the compensation signal is used by the control circuit to compensate for the detected RV events, wherein the compensation signal accounts for self-induced RV events generated by a SEEK operation that repositions the respective head to a new track. In some embodiments, operation of at least a portion of the adaptive feed forward circuit is suppressed during the SEEK operation (1410). In some embodiments, the PES itself is suppressed during the SEEK operation (1408), which effectively suppresses the operation of at least a portion of the adaptive feed forward circuit during the SEEK operation.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1 A disk drive assembly, comprising:
a disk drive including one or more heads and one or more tracks;
one or more accelerometers configured to generate acceleration signals that are used to detect rotational vibration (RV) events on the disk drive;
a control circuit configured to:
generate one or more control signals, wherein a respective control signal positions a respective head on a respective track for the disk drive, wherein the respective control signal is based on a control signal from a host system and a compensation signal from an adaptive feed forward circuit; and
generate a position error signal (PES) that indicates an error in a position of the respective head relative to a center of the respective track;
the adaptive feed forward circuit configured to generate the compensation signal that compensates for the detected RV events based on the acceleration signals and the PES, wherein the compensation signal accounts for self-induced RV events generated by a SEEK operation that repositions the respective head to a new track, and wherein operation of at least a portion of the adaptive feed forward circuit is suppressed during the SEEK operation.

2. The disk drive assembly of claim 1, wherein the at least the portion of the adaptive feed forward circuit is suppressed during the SEEK operation and for a specified time period after the SEEK operation has completed.

3. The disk drive assembly of claim 1, wherein the adaptive feed forward circuit includes:
a multiplier circuit configured to:
receive a rotational acceleration signal and a scaling factor generated by an integrator circuit; and
generate the compensation signal by multiplying the rotational acceleration signal and the scaling factor generated by the integrator circuit;
a correlator circuit configured to generate a correlation signal based on the compensation signal and the PES; and
the integrator circuit configured to generate the scaling factor by integrating the correlation signal.

4. The disk drive assembly of claim 3, wherein the adaptive feed forward circuit includes:
a high-pass filter (HPF) interposed between the PES and the correlator circuit, wherein the HPF is configured to:
receive the PES; and
generate a filtered PES signal, wherein DC components of the PES have been substantially removed from the filtered PES signal.

5. The disk drive assembly of claim 4,
wherein the pole frequency of the HPF is adjustable; and
wherein the pole frequency of the HPF is reduced to a specified frequency.

6. The disk drive assembly of claim 3, wherein
the pole frequency of the HPF is adjustable;
the pole frequency of the HPF is set to a predefined first frequency when the disk drive is not performing a SEEK operation; and
the pole frequency of the HPF is set to a predefined reduced frequency when the disk drive is performing a SEEK operation.

7. The disk drive assembly of claim 4,
wherein the adaptive feed forward circuit includes a first switch between an output of the correlator circuit and an input of the integrator circuit, and a second switch between the PES and an input of the HPF;
wherein when the disk drive is performing a SEEK operation, the first switch is configured to produce an open circuit between the output of the correlator circuit and the input of the integrator circuit, and the second switch is configured to couple the input of the HPF to a zero error signal; and
wherein when the disk drive is not performing a SEEK operation, the first switch is configured to couple the output of the correlator circuit to the input of the integrator circuit, and the second switch is configured to couple to the PES to the input of the HPF.

8. The disk drive assembly of claim 4,
wherein at least a portion of the HPF is disabled when the disk drive is performing a SEEK operation; and
wherein the HPF is enabled when the disk drive is not performing a SEEK operation.

9. The disk drive assembly of claim 8, wherein at least a portion of the HPF is disabled by maintaining a state of the HPF at the state of the HPF prior to when the HPF was disabled.

10. The disk drive assembly of claim 4, including:
a SEEK input pin configured to receive a SEEK input signal generated by the control circuit; and
a first switch between an output of the correlator circuit and an input of the integrator circuit;
wherein when the SEEK input signal indicates that the disk drive is performing a SEEK operation, the first switch is configured to produce an open circuit between the output of the correlator circuit and the input of the integrator circuit; and
wherein when the SEEK input signal indicates that the disk drive is not performing a SEEK operation, the first switch is configured to couple the output of the correlator circuit to the input of the integrator circuit.

11. The disk drive assembly of claim 4, including a SEEK detection circuit configured to detect when the disk drive is performing a SEEK operation.

12. The disk drive assembly of claim 11,
wherein the SEEK detection circuit includes a comparator circuit configured to compare the PES with a specified SEEK threshold;
wherein when the PES exceeds the specified SEEK threshold, the SEEK detection circuit generates a SEEK detection signal that indicates that the disk drive is performing a SEEK operation; and
wherein when the PES does not exceed the specified SEEK threshold, the SEEK detection circuit generates a SEEK detection signal that indicates that the disk drive is not performing a SEEK operation.

13. A disk drive assembly, comprising:
a disk drive including one or more heads and one or more tracks;
one or more accelerometers configured to generate acceleration signals that are used to detect rotational vibration (RV) events on the disk drive;
a control circuit configured to:
generate one or more control signals, wherein a respective control signal positions a respective head on a respective track for the disk drive, wherein the respective control signal is based on a control signal from a host system and a compensation signal from an adaptive feed forward circuit; and
generate a position error signal (PES) that indicates an error in a position of the respective head relative to a center of the respective track;
the adaptive feed forward circuit configured to generate the compensation signal that compensates for the detected RV events based on the acceleration signals and the PES, wherein the compensation signal accounts for self-induced RV events generated by a SEEK operation that repositions the respective head to a new track, and wherein the control circuit generates a zero error signal for the PES that is received by the adaptive feed forward circuit from the control circuit when the disk drive is performing a SEEK operation.

14. The disk drive assembly of claim 13, wherein the adaptive feed forward circuit includes:
a multiplier circuit configured to:
receive a rotational acceleration signal and a scaling factor generated by an integrator circuit; and
generate the compensation signal by multiplying the rotational acceleration signal and the scaling factor generated by the integrator circuit;
a correlator circuit configured to generate a correlation signal based on the compensation signal and the PES; and
the integrator circuit configured to generate the scaling factor by integrating the correlation signal.

15. The disk drive assembly of claim 14, wherein the adaptive feed forward circuit includes:
a high-pass filter (HPF) interposed between the PES and the correlator circuit, wherein the HPF is configured to:
receive the PES; and
generate a filtered PES signal, wherein DC components of the PES have been substantially removed from the filtered PES signal.

16. The disk drive assembly of claim 15,
the control circuit including a SEEK detection circuit configured to detect when the disk drive is performing a SEEK operation and to generate the zero error signal for the PES that is received by the adaptive feed forward circuit from the control circuit when the disk drive is performing the SEEK operation;
the adaptive feed forward circuit including a PES input pin configured to receive the PES generated by the control circuit.

17. The disk drive assembly of claim 14, wherein the correlator circuit is a multiplier circuit.

18. A system, comprising:
one or more processors;
memory; and
one or more programs stored in the memory, the one or more programs comprising instructions to:
receive from one or more accelerometers acceleration signals that are used to detect rotational vibration (RV) events on a disk drive;
receive from a control circuit a position error signal (PES) that indicates an error in a position of a respective head relative to a center of a respective track; and
generate a compensation signal based on the acceleration signals and the PES, wherein the compensation signal is used by the control circuit to compensate for the detected RV events, wherein the compensation signal accounts for self-induced RV events generated by a SEEK operation that repositions the respective head to a new track, and wherein operation of at least a portion of the adaptive feed forward circuit is suppressed during the SEEK operation.

19. The system of claim 18, wherein the at least the portion of the adaptive feed forward circuit is suppressed during the SEEK operation and for a specified time period after the SEEK operation has completed.

20. A computer readable storage medium storing one or more programs configured for execution by a computer, the one or more programs comprising instructions for:
receiving from one or more accelerometers acceleration signals that are used to detect rotational vibration (RV) events on a disk drive;
receiving from a control circuit a position error signal (PES) that indicates an error in a position of a respective head relative to a center of a respective track; and
generating a compensation signal based on the acceleration signals and the PES, wherein the compensation signal is used by the control circuit to compensate for the detected RV events, wherein the compensation signal accounts for self-induced RV events generated by a SEEK operation that repositions the respective head to a new track, and wherein operation of at least a portion of the adaptive feed forward circuit is suppressed during the SEEK operation.

21. The computer readable storage medium of claim 20, wherein the at least the portion of the adaptive feed forward circuit is suppressed during the SEEK operation and for a specified time period after the SEEK operation has completed.
